(19) United States
(12) Patent Application Publication
(10) Pub. No.: US 2002/0136043 A1
(43) Pub. Date: Sep. 26, 2002

(54) Audio device incorporated into printed matter

(76) Inventor: Linda Isioma Manuela IIoba, Bowie, MD (US)

Correspondence Address: John Dodds, 1707 N St., N.W., Washington, DC, 20036, US

(21) Appl. No.: 10/068,350

(22) Filed: Feb. 6, 2002

Related U.S. Application Data
(60) Provisional application No. 60/278,595, filed on Mar. 24, 2001.

(51) Int. Cl. G09B 15/02

(52) U.S. Cl. 365/1; 84/471 R

(57) ABSTRACT

This invention relates to the embedding of a microelectronic chip into printed media, including but not limited to books and magazines. The microelectronics component is switched on by opening the printed medium or by triggering an on /off mechanism. The invention may have various embodiments that can be to project speech, music or other tonal signals upon operation.

### BACKGROUND & CROSS REFERENCES TO RELATED APPLICATIONS

This application is entitled to benefit of Provisional Patent Application Serial Number 60/278,595 filed Mar. 21, 2001.

### BACKGROUND: FEDERALLY SPONSORED RESEARCH

The invention disclosed herein was not sponsored in any part by any federal agency. No government rights are reserved.

### REFERENCE TO MICROFICHE APPLICATION

Not Applicable

### BACKGROUND: FIELD OF INVENTION

The invention is in the field of books and magazines into which embodied microelectronics can be used to generate sound messages and musical tones.

### BACKGROUND: DISCUSSION OF PRIOR ART

There are books and greeting cards in the market that employ musical elements to entertain or to send a message to the reader. Examples of this are the musical greeting cards and children's books such as the children's book with pop up toy described in U.S. Pat. No. 5,681,199 (Morris, 1997). Moreover, U.S. Pat. No. 5,569,868 (Leung, 1996) describes a sound-generating book that has a plurality of sensors, including transmitters and receivers positioned at various sections of the book for triggering sound generation; and U.S. Pat. No. 5,538,430 (Smith et al, 1996) explains a self-reading electronic child's book. Finally, U.S. Pat. No. 5,575,383 (Seeley, 1996) claims a container having an audible signaling device. However, none of the aforementioned inventions claim the embedding of a microelectronic chip into printed media, such as books and magazines; and that the microelectronic chip is switched on by a definite action of the reader, generating speech, music or other tonal signals. Furthermore, the prior art refers basically to musical greeting cards and children's books, and these are not the subject to which the present invention refers to. Furthermore, this invention is applied to adults' books and magazines and these are clearly not containers of audible signaling devices of speech, music or other tonal signals per se. Therefore, the present invention is not contained in the prior art.

### SUMMARY

This invention relates to the embedding of a microelectronic chip into printed media, such as books and magazines such that the microelectronics is switched on by a definite action by the reader, such as opening the printed matter, or by means of an on/ off trigger mechanism. The invention may have various embodiments that can be to project speech, music or other tonal signals upon operation.

### OBJECTS & ADVANTAGES

This device allows a more holistic experience to the user of the printed medium. It may be used to provide sound additions to the reading experience.

This device can be used to make books and reading more attractive for adults.

This device can be used to remember where you were in reading a book or magazine.

This device can be used as an advertising tool.

### DESCRIPTION OF DRAWINGS

Not Applicable

### LIST OF REFERENCE NUMERALS

Not applicable

### DESCRIPTION OF INVENTION

This invention relates to the embodiment of a microelectronic device into a printed matter, such as a book or magazine. The device has an on/ off switch mechanism that may be triggered by the opening of said printed matter or by the use of an on /off trigger device. The device also contains a micro power supply that feeds energy to operate the device.

When the printed matter is opened, or the switch is operated causing the microelectronic device is switched on, the device will emit in audible tones an audio message. The message may be voice, music or a combination thereof. The device may also produce messages of varying length and complexity.

One embodiment of the device is the emission of a single message. There may be other embodiments that will customize the emitted messages to certain indicators of the printed matter; for example, opening of each chapter of a book may elicit a different message or music.

Other attributes may be attributable to the chip, such as a memory device to allow the reader to customize their own message, memory devices that allow the chip to indicate at what point the reader stopped reading the printed matter.

A range of embodiments related to the method of embedding the microelectronic device into the printed matter. The preferred embodiment is the fixing of the device to the inner edge of the spine and or cover of the book or magazine, an alternative embodiment may be the sandwiching of the device between blank pages of the printed matter.

### DESCRIPTION AND OPERATION OF ALTERNATIVE EMBODIMENTS

There is a range of different embodiments of the general model as applied to a wide range of reading/print media. The preferred embodiment is a chip that will play a short musical excerpt when a book is opened.

Although the present invention has been described with reference to the preferred embodiment thereof, it should be understood that it is in no way limited to the details of such embodiment but is capable of numerous modifications within the scope of the appended claims.

### CONCLUSION, RAMIFICATION & SCOPE OF INVENTION

It should be emphasized that what is described in this application is the preferred embodiment of the invention, however, the invention is capable of numerous modifications within the scope of the appended claims. The scope of the invention will be based on the claims on such invention.

I claim:

1. A microelectronic device embodied into a printed matter and that is capable of reproducing sounds from a memory integrated circuit, comprising of:
(a) a memory device for storing data,
(b) a printed matter,
(c) a micro power supply that feeds energy to operate said microelectronic device.

2. Said microelectronic device referred to in claim 1 where the printed matter may be a book.

3. Said device referred to in claim 1 where the printed matter may be a magazine.

4. Said device referred to in claim 1 where the sounds are emitted in audible tones by activating a trigger mechanism.

5. Said mechanism referred to in claim 4 may be triggered by opening of the printed matter.

6. Said mechanism referred to in claim 4 may be triggered by the use of an off-on switch.

7. Said device referred to in claim 1 where the sounds may be a message emitted by a human voice.

8. Said device referred to in claim 1 where the sounds may be a message of music.

9. Said device referred to in claim 1 where the sounds may be a combination of human voice as speech and music.

10. The sounds referred to in claim 7 may vary in length.

11. The sounds referred to in claim 7 may vary in complexity.

12. The sounds referred to in claim 7 may be a single message.

13. The sounds referred to in claim 7 may be various messages.

14. The sounds referred to in claim 7 may be emitted by certain indicators in the printed matter.

15. The indicators referred to in claim 14 may be the opening of different parts of the printed matter.

16. An indicator referred to in claim 14 may be pressing an area of the printed matter.

17. An indicator referred to in claim 14 may be by physical contact with the printed matter.

18. The memory device referred in claim 1 may be an integrated circuit.

19. The memory device referred to in claim 1 may allow the reader to customize his or her own message.

20. The memory device referred to in claim 1 wherein it indicates to the reader at what point he or she stopped reading the printed matter.

21. The memory device referred to in claim 1 wherein it indicates to the reader at what point he or she stopped reviewing the printed matter.

22. The microelectronic device referred to in claim 1 wherein such device is fixed in the inner edge of the spine of the printed matter.

23. The microelectronic device referred to in claim 1 wherein such device is fixed in the inner edge of the cover of the printed matter.

24. The microelectronic device referred to in claim 1 wherein it is placed or sandwiched in between pages of the printed matter.
